(19) United States
(12) Patent Application Publication
(10) Pub. No.: US 2009/0152900 A1
(43) Pub. Date: Jun. 18, 2009

(54) COUPLING STRUCTURE OF HOOD STAY ROD AND CAP IN VEHICLE

(75) Inventor: Jaehwan Kyung, Seoul (KR)

Correspondence Address: MORGAN, LEWIS & BOCKIUS LLP (SF), One Market, Spear Street Tower, Suite 2800, San Francisco, CA, 94105, US

(73) Assignee: Kia Motors Corporation, Seoul (KR)

(21) Appl. No.: 12/177,392

(22) Filed: Jul. 22, 2008

(30) Foreign Application Priority Data
Dec. 14, 2007 (KR) 10-2007-0130860

(51) Int. Cl. B62D 25/12

(52) U.S. Cl. 296/193.11

(57) ABSTRACT

The present invention relates to a coupling structure of a hood stay rod and a cap in a vehicle in which a hitch piece slantingly formed the cap is suspended on a hitch jaw of the hood stay rod, whereby the cap is coupled with the hood stay rod so as to reduce manufacturing cost by coupling the hood stay rod with the cap in a method of joining a plastic cap to the front end portion of a steel hood stay rod through a hitch jaw and a hitch piece and to improve productivity by lowering the defect rate of a product.

### CROSS-REFERENCE TO RELATED APPLICATIONS

The present application is based on, and claims priority from, Korean Application Serial Number 10-2007-0130860, filed on Dec. 14, 2007, the disclosure of which is hereby incorporated by reference herein in its entirety.

### FIELD OF THE INVENTION

The present invention relates to a hood stay rod cap in a vehicle, and more particularly, to a coupling structure of a hood stay rod and a cap in a vehicle, which are adapted to improve the manufacturing property of the hood stay rod and reduce a manufacturing cost by joining the hood stay rod cap to a frond end portion of a hood stay rod in a hitch method.

### BACKGROUND OF THE INVENTION

Generally, a hood of a vehicle is used to open and close an engine room installed in the front of a vehicle body, a bracket mounted on a hood panel and a bracket installed in the vehicle body are connected to each other by a hinge, the engine room is opened and closed while the hood rotates through the hinge, and a gas lift is installed to maintain an opened state of the hood. However, small-sized vehicles maintain the opened state of the hood by using the hood stay rod for the reason of the curtailment of cost.

One end of the hood stay rod is pivotally installed in the vehicle body and the other end of the hood stay rod is detachably suspended on a hitch hole provided on an inner panel of the hood to thereby maintain the opened state of the hood.

In the related art, a hood stay rod is formed in the shape of a substantially straight bar and made of steel so as to ensure rigidity, and a plastic cap is put on the front end portion of hood stay rod.

Cap is manufactured by insert-injecting a plastic material with fully surrounding the front end portion of hood stay rod after hood stay rod is molded and then inserted into a mold. Cap includes a hood stay rod joining part that is injection-molded so as to fully fit and surround the front end portion of hood stay rod, a base part that is integrally formed to be larger than hood stay rod joining part and is seated on the hood panel, and an insertion part that is integrally formed with base part, and inserted into and suspended on the hitch hole formed on the hood panel.

However, as described above, in the known method of injection-molding the cap, since the manufacturing cost of the cap becomes higher, the curtailment of the cost of the vehicle is difficult. Further, since the plastic cap is put on and attached to the steel hood stay rod made of steel by injection molding, the adhesion force between the cap and the hood stay rod is weakened, whereby there was a fear that the cap will be separated from the hood stay rod and there was a drawback that an additional sealer application process is required to fill a gap between the cap and the hood stay rod or strengthen an adhesion force between the cap and the hood stay rod.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provides a coupling structure of a hood stay rod and a cap in a vehicle, which are adapted to reduce a manufacturing cost by coupling the hood stay rod with the cap in a method of joining a plastic cap to the front end portion of a steel hood stay rod through a hitch jaw and a hitch piece and to improve productivity by lowering the defect rate of a product.

According to an embodiment of the present invention, a hitch piece slantingly formed in the cap is engaged to a hitch jaw formed in the hood stay rod, so that the cap is coupled with the hood stay rod.

The cap may include: a base that is manufactured by injecting a plastic material and has a substantially rectangular shape; a hood stay rod fitting part that integrally protrudes from the base so as to extend downward and has a coupling hole into which a front end portion of the hood stay rod is inserted; an insertion part that integrally protrudes from the base so as to extend upward, has a substantially ‘U’ shape, and is inserted into and suspended on a hitch hole formed on a hood panel, and the hitch piece being integrally protruded from an inner circumference of the insertion part.

A triangular hitch jaw, which is inserted into and suspended on the hitch hole formed on the hood panel, integrally may protrude from an external surface of the insertion part.

In another embodiment of the present invention related to a coupling structure of a hood stay rod and a cap in a vehicle, the cap may comprise: a base; an insertion part extending upwards from an upper portion of the base and forming an inner coupling space; and a hood stay rod fitting part extending downwards from a lower portion of the base, the hood stay rod fitting part including a coupling hole therethrough, and the hood stay rod may include: a body shaped substantially linear; and a hitch jaw inscribed into an external circumference of a front end portion of the body with a predetermined angle. The base may have a substantially rectangular shape.

The insertion part may comprise: at least an insertion guide portion integrally protruding from the upper portion of the base; and a connecting portion integrally connecting the at least an insertion guide portion. The at least a insertion guide portion and the connecting portion of the insertion part may be substantially ‘U’ shaped and configured to form the inner coupling space.

The insertion part may further comprise: a hitch piece integrally protruded from an inner circumference of the insertion part with a predetermined angle; and a hitch jaw integrally protruded from an external circumference of the insertion part with a predetermined angle. The predetermined angle of the hitch piece and the predetermined angle of the hitch jaw may be opposite each other with respect to a longitudinal direction of the insertion guide portion of the insertion part.

The hitch piece of the insertion part may be inserted into and engaged with the hitch jaw of the hood stay rod as the front end portion of the body of the hood stay rod is compulsorily pushed into the inner coupling space of the cap through the insertion hole of the cap. The hitch jaw may be shaped triangular. The hitch jaw of the insertion part may be inserted into and engaged with a hitch hole formed on the hood panel.

In the coupling structure of a hood stay rod and a cap in a vehicle according to the embodiments of the present invention, when the cap is put on the front end portion of the hood stay rod, the hitch piece formed in the cap is suspended on the hitch jaw formed in the hood stay rod so that the cap is coupled with hood stay rod. For this reason, the cap does not need to be insert-injected. Therefore, the manufacturing cost of the vehicle can be curtailed by lowering the manufacturing cost of the cap, the defect rate of the product can be remarkably reduced by the strengthening of the coupling force between the cap and the hood stay rod, and an additional post process such as the application of a sealer is not required, which improves productivity.

### BRIEF DESCRIPTION OF THE DRAWINGS

For a better understanding of the nature and objects of the present invention, reference should be made to the following detailed description with the accompanying drawings, in which:

FIG. 1 is a perspective view of a cap according to an embodiment of the present invention;

FIG. 2 is a perspective view of a hood stay rod provided with a hitch jaw according the present invention; and

FIG. 3 is a perspective view of the hood stay rod coupled with the cap according to the embodiment of the present invention.

### DETAILED DESCRIPTION OF PREFERRED EMBODIMENTS

Hereinafter the present invention will be described in detail with reference to the accompanying drawings.

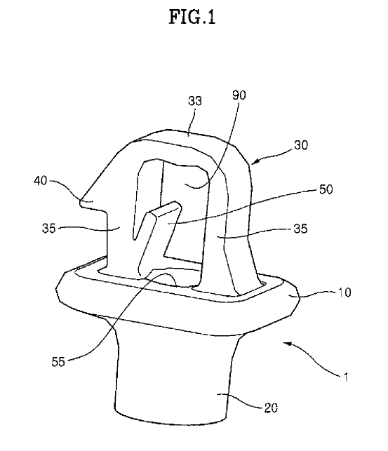

Referring to FIG. 1, a cap 1 according to the embodiment of the present invention includes a base 10 that is manufactured by injecting a plastic material and has a substantially rectangular shape, a hood stay rod fitting part 20 that integrally protrudes from a lower portion of the base 10 so as to extend downward and has a coupling hole 55 into which a front end portion 70 of a hood stay rod 60 is inserted, and an insertion part 30. The insertion part 30 comprises at least an insertion guide portion 35 and a connecting portion 33, wherein the insertion guide portions 35 integrally protrude from an upper portion of the base 10 so as to extend upward and the connecting portion 33 integrally connects the insertion guide portions 35 and thus the insertion guide portions 35 and the connecting portion 33 form substantially a ‘U’ shape. The insertion part 30 is inserted into and suspended on a hitch hole formed on a hood panel (not shown).

A triangular hitch jaw 40 integrally protrudes from an external circumference of the at least an insertion guide portion 35 of the insertion part 30 and slanted towards the base 10 with a predetermined degree so that the insertion part 30 is easily inserted into but difficult to be separated from the hitch hole of the good panel once the insertion part 30 is inserted into the hitch hole.

A hitch piece 50 that protrudes slantingly toward the connecting portion 33 of the insertion part 30 and is engaged with hitch jaw 80 of the hood stay rod 60 integrally protrudes from an inner circumference of the at least an insertion guide portion 35 of the insertion part 30.

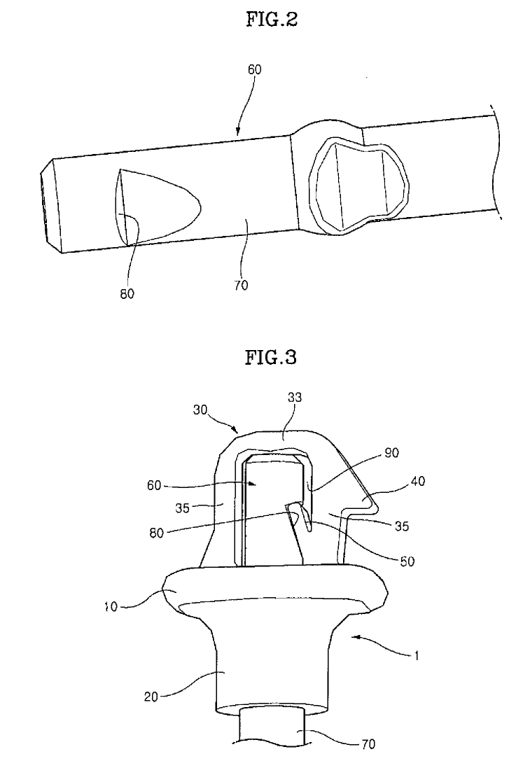

FIG. 2 illustrates a front end portion 70 of a hood stay rod 60 with which the above-mentioned cap 1 is coupled. The hitch jaw 80 formed by cutting inside an outer circumference of a front end of hood stay rod 60 with a predetermined angle is provided at front end portion 70 of the hood stay rod 60.

In case of coupling the cap 1 manufactured as described above to the hood stay rod 60, as shown in FIG. 3, when opened hitch piece 50 of cap 1 is compulsorily pushed to the insertion guide portion 35 of the insertion part 30 by the front end portion 70 of the hood stay rod 60 and then the hitch piece 50 is positioned in the hitch jaw 80 of the hood stay rod 60 by inserting the front end portion 70 of hood stay rod 60 into the coupling hole 55 formed through the hood stay rod fitting part 20 of cap 1 and pushing the front end portion 70 to an inner coupling space 90 formed by the insertion guide portion 35 and the connecting portion 33 of the insertion part 30, a front end of hitch piece 50 is engaged with the hitch jaw 80 of the hood stay rod 60 while the hitch piece 50 is returned to its home position by the elastic force of the hitch piece 50, whereby the cap 1 is engaged with the hood stay rod 60.

That is, the cap can be easily coupled with the hood stay rod by the simple fitting method and a state that the cap is coupled with the hood stay rod can be consistently and stably maintained by an interaction between the hitch piece of the cap and the hitch jaw of the hood stay rod.

Hence, since the cap does not need to be manufactured by the insert-injection method, the manufacturing cost of the cap can be lowered and the defect rate of a product which occurred at injection-molding the cap can be remarkably reduced.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents

What is claimed is:

1. A coupling structure of a hood stay rod and a cap in a vehicle, wherein a hitch piece slantingly formed in the cap is engaged to a hitch jaw formed in the hood stay rod, so that the cap is coupled with the hood stay rod.

2. The coupling structure as defined in claim 1, wherein the cap includes:
a base that is manufactured by injecting a plastic material and has a substantially rectangular shape;
a hood stay rod fitting part that integrally protrudes from the base so as to extend downward and has a coupling hole into which a front end portion of the hood stay rod is inserted;
an insertion part that integrally protrudes from the base so as to extend upward, has a substantially ‘U’ shape, and is inserted into and suspended on a hitch hole formed on a hood panel, and the hitch piece being integrally protruded from an inner circumference of the insertion part.

3. The coupling structure as defined in claim 2, wherein a triangular hitch jaw, which is inserted into and suspended on the hitch hole formed on the hood panel, integrally protrudes from an external surface of the insertion part.

4. A coupling structure of a hood stay rod and a cap in a vehicle, wherein the cap comprises:
a base;
an insertion part extending upwards from an upper portion of the base and forming an inner coupling space; and
a hood stay rod fitting part extending downwards from a lower portion of the base, the hood stay rod fitting part including a coupling hole therethrough, and wherein the hood stay rod includes:
a body shaped substantially linear; and
a hitch jaw inscribed into an external circumference of a front end portion of the body with a predetermined angle.

5. The coupling structure as defined in claim 4, wherein the base has a substantially rectangular shape.

6. The coupling structure as defined in claim 4, wherein the insertion part comprises:
at least an insertion guide portion integrally protruding from the upper portion of the base; and
a connecting portion integrally connecting the at least an insertion guide portion.

7. The coupling structure as defined in claim 6, wherein the at least a insertion guide portion and the connecting portion of the insertion part are substantially ‘U’ shaped and configured to form the inner coupling space.

8. The coupling structure as defined in claim 4, wherein the insertion part further comprises:
a hitch piece integrally protruded from an inner circumference of the insertion part with a predetermined angle; and
a hitch jaw integrally protruded from an external circumference of the insertion part with a predetermined angle.

9. The coupling structure as defined in claim 8, wherein the predetermined angle of the hitch piece and the predetermined angle of the hitch jaw are opposite each other with respect to a longitudinal direction of the insertion guide portion of the insertion part.

10. The coupling structure as defined in claim 8, wherein the hitch piece of the insertion part is inserted into and engaged with the hitch jaw of the hood stay rod as the front end portion of the body of the hood stay rod is compulsorily pushed into the inner coupling space of the cap through the insertion hole of the cap.

11. The coupling structure as defined in claim 8, wherein the hitch jaw is shaped triangular.

12. The coupling structure as defined in claim 8, wherein the hitch jaw of the insertion part is inserted into and engaged with a hitch hole formed on the hood panel.
